(19) United States
(12) Patent Application Publication
(10) Pub. No.: US 2018/0154193 A1
(43) Pub. Date: Jun. 7, 2018

(54) Cartridge for a Breathing Mask, and a Breathing Mask

(71) Applicant: MANN+HUMMEL GmbH, Ludwigsburg (DE)

(72) Inventors: Joachim Stinzendoerfer, Speyer (DE); Susanne Lehnert, Mannheim (DE); Christopher Jeblick, Schifferstadt (DE); Mike Maertz, Mannheim (DE); Steffen Ackermann, Harthausen (DE); Stefan Diersch, Trebgast (DE)

(21) Appl. No.: 15/888,032

(22) Filed: Feb. 4, 2018

Related U.S. Application Data
(63) Continuation of application No. PCT/EP2016/068584, filed on Aug. 3, 2016.

(30) Foreign Application Priority Data
Aug. 3, 2015 (DE) 10 2015 009 829.2

(51) Int. Cl. A62B 19/00; A62B 18/02; A62B 23/02; C09J 7/21; C09J 9/00; C09J 11/04

(52) U.S. Cl. CPC A62B 19/00; A62B 18/02; A62B 23/02; C09J 7/21; C09J 2400/10; C09J 11/04; C09J 2475/00; C09J 2483/00; C09J 2423/00; C09J 9/00

(57) ABSTRACT

A cartridge for a breathing mask is provided with a housing and an adsorption filter section arranged in the housing. The adsorption filter section is provided with one or more carrier media and one or more activated carbon layers with activated carbon particles. The activated carbon particles are immobilized in the activated carbon layers by a fixation agent. A fine filter section is arranged fluidically upstream of the adsorption filter section and separates contaminants from the breathing air. The cartridge has a flow-through connecting element and the breathing mask has a flow-through counter element, wherein the connecting element and the counter element interact to connect the cartridge to the breathing mask. The breathing mask has a shut-off element that fluid-tightly close off the counter element when the cartridge is removed from the counter element.

### CROSS-REFERENCE TO RELATED APPLICATIONS

This application is a continuation application of international application No. PCT/EP2016/068584 having an international filing date of 3 Aug. 2016 and designating the United States, the international application claiming a priority date of 3 Aug. 2015, based on prior filed German patent applications No. 10 2015 009 829.2, the entire contents of the aforesaid international application and the aforesaid German patent application being incorporated herein by reference.

### BACKGROUND OF THE INVENTION

The invention concerns a cartridge for a breathing mask with an adsorption filter, in particular for protection when handling dangerous, health-hazardous materials, as well as a breathing mask with a cartridge.

As breathing masks for protection of the operators when handling dangerous, health-hazardous materials but also for entering possibly hazardous environments, as, for example, after fires, face masks are usually employed for filtration of the breathing air with gas filter cartridges that are primarily comprised of a particle/aerosol filter medium and a loose filling of activated carbon.

DE 10 2013 008 389 A1 discloses a filter element with a filter body with a closed exterior side that surrounds a closed inner side which encloses a central flow space. In this context, a filter medium is arranged between exterior side and inner side. The filter body comprises a wound layer with an adsorbent material such as activated carbon. Due to the configuration with wound layers, the filter element provides a sufficiently high contact time of the medium to be filtered with the adsorbent material which thereby purifies the medium to be filtered. The filter element is provided, for example, for purifying the cathode air of a fuel cell system. The filter body comprises a support body onto which a layer with an adsorbent material is applied. By winding the support body, for example, onto a suitable inner core to the desired diameter or desired cross section, the support body is provided with its shape. In this context, for immobilization of the adsorbent material, the support body is comprised of layers of strip-shaped support material between which an adsorbent material layer is arranged.

### SUMMARY OF THE INVENTION

It is an object of the invention to provide a cartridge for a breathing mask which enables a robust use and at the same time provides excellent efficiency for a long period of time.

A further object of the invention is to provide a breathing mask with a cartridge which enables a robust use and at the same time provides excellent efficiency for a long period of time.

The aforementioned objects are solved according to an aspect of the invention by a cartridge for a breathing mask with an adsorption filter section wherein the adsorption filter section comprises a carrier medium and an activated carbon layer in which activated carbon particles are immobilized by addition of a fixation agent.

Beneficial configurations and advantages of the invention result from the further claims, the description, and the drawing.

A cartridge for a breathing mask is proposed, comprising an adsorption filter section arranged in a housing. In this context, the adsorption filter section comprises a carrier medium and an activated carbon layer in which activated carbon particles are immobilized by addition of a fixation agent.

The cartridge according to the invention can be employed in order to filter out contaminants in a gas stream by physical and/or chemical action by adsorption or absorption. The cartridge can be used for filtering breathing air in a possibly hazardous environment, for example, after fires, in that gaseous contaminants in the air are adsorbed. The filter device comprises, on the one hand, a carrier medium and, on the other hand, activated carbon as an adsorption agent, which according to the invention is immobilized by a fixation agent. This makes it possible to realize densely packed activated carbon layers that, in contrast to loose activated carbon bulk fillings, maintain their structure even in case of mechanical load over a long operating period; displacements and local compaction of the activated carbon particles that may cause impairment of the adsorption efficiency are avoided. Impairment of the adsorption efficiency is caused, for example, by local voids in the loose filling which can lead to leakage. In the embodiment according to the invention, due to the immobilization of the activated carbon particles, the air permeability is higher compared to loose fillings with activated carbon particles of comparable particle diameter. The immobilization of the activated carbon particles has furthermore the advantage that different geometries of the filter device or of the layers of the carrier medium and of the activated carbon can be generated. Conceivable are round, oval, rectangular shapes as well as any other shapes.

According to an advantageous embodiment, at least one fine filter section which is fluidically arranged upstream of the adsorption filter section can be provided for separation of contaminants from the breathing air, in particular for separation of aerosols. By the combination of adsorption filter section and fine filter section it is possible to achieve reliably a high quality of the filtered breathing air even in greatly loaded environments. The adsorption filter section binds in particular health-hazardous gases and/or gases with unpleasant odor; the fine filter section arranged upstream or downstream of the adsorption filter section removes fine dusts and aerosols from the breathing air. The fine filter section is preferably arranged upstream of the adsorption filter section.

In an embodiment, as a fine filter section a non-folded filter medium, in particular a filter medium that is of an annular shape or is stacked, can be employed. In another embodiment, a zigzag-shape folded filter medium, in particular a star-shape folded, round filter medium can be employed. Beneficial is a filter medium with glass fibers in a glass fiber layer, in particular in a glass fiber composite layer, a filter medium of cellulose, or a meltblown or spunbonded fabric or a mixed or multi-layer combination thereof. A non-folded filter medium can be embodied as a flat layer of filter medium and, for example, can be of an annular shape or can be stacked in several layers to a filter stack. In this context, for example, a glass fiber nonwoven or glass fiber paper can be employed that comprises preferably a cover layer of a spunbonded fabric applied to one face or both faces. In this way, in particular a mechanical protection of the often very sensitive glass fiber medium is achieved, which is in particular advantageous when the glass fiber layer is folded because then the medium in particular can be protected during folding from damage which could cause local leaks or tears. Moreover, such cover layers can serve for improving the mechanical strength of the fine filter section.

Instead of glass fibers, synthetic fibers can also be employed for the fine filter section. In particular, a synthetic medium can be employed in place of the described glass fiber media. In this context, for example, polyester or polypropylene or polyamide can be employed as a material; in this context, the fiber layers are preferably in nonwoven form and manufactured, for example, by the so-called electrospinning method, by the meltblowing method, or in any other ways. In particular, a filter medium can be employed in the fine filter section which corresponds in regard to the filtration performance to the class H13 according to the standard EN1822:2009.

When the adsorption filter section is embodied as a stack of activated carbon layers, the fine filter section, in particular when it is embodied as a round filter, can be arranged at a spacing from the adsorption filter section. In this way, the flow of the prefiltered air, which is directed through the round filter radially toward the interior in the direction of the longitudinal axis of the round filter, can again be distributed so that the air can pass areally across the complete surface area of the first activated carbon layer into the stack of activated carbon layers and in this way can flow through the stack in the stacking direction.

In an embodiment, additionally a prefilter layer can be provided at the inflow side, in particular for coarse dust separation. It can be arranged fluidically upstream of the fine filter section and can be arranged at the inflow side of the cartridge. In this way, even in greatly dust-laden environments a reliable function of the adsorption filter section and of the fine filter section can be ensured and the dust loading of the incoming air can be reduced.

The housing of the cartridge can be manufactured of plastic material, in particular by an injection molding process as a molded shell. Alternatively, also a metal housing, for example, of aluminum is conceivable.

According to an advantageous embodiment, the fixation agent in the activated carbon layer can be a reactive adhesive, for example, on the basis of polyurethane or silane. Alternatively, the adhesive in the activated carbon layer can be a thermoplastic adhesive, for example, on the basis of polyolefins. According to the invention, the loose activated carbon bulk filling of a conventional cartridge is replaced in this way by a fixed filling as a flat, manipulatable adsorbent filter medium. The great advantage in this context is that the fixed filling cannot change geometrically because the activated carbon particles are fixed relative to each other by the adhesive. In addition, on the surfaces of the activated carbon layer a boundary nonwoven can be applied as a carrier medium. An activated carbon layer which has been immobilized in this way exhibits decisive advantages in comparison to a loose filling which is compressed by movements, impact and shaking movements and whose breakthrough time for the materials to be removed, in particular to be adsorbed, can be possibly reduced thereby. The immobilization of the activated carbon particles in the activated carbon layer is achieved by the addition of adhesive whose adhesive strings adhere to the surface of the activated carbon particles and connect different activated carbon particles with each other without however impairing the adsorption performance of the activated carbon.

According to an advantageous embodiment, the carrier medium can be embodied as a nonwoven, in particular as a filter nonwoven for particle separation. The carrier medium is the carrier of the activated carbon or at least adjoins the activated carbon layer. The carrier medium is embodied, for example, as a carrier layer or ply that provides a mechanical filtration of particulate contaminants of the gaseous fluid to be purified, for example, air. In this case, the carrier medium, for example, forms a carrier or filter nonwoven on which dirt particles can be separated. The nonwoven can be comprised, for example, of polyester, polypropylene, polyamide, polyacrylonitrile or polycarbonate.

In an embodiment of the carrier medium as a carrier layer, the activated carbon forms an activated carbon layer which adjoins immediately the carrier layer and is preferably connected by means of the adhesive with the carrier layer. In this context, it is conceivable that the activated carbon layer is glued onto the carrier layer as well as that an adhesive connection by not yet cured adhesive strings applied to the activated carbon is formed. The carrier layer delimits thus the activated carbon layer at least at one face and is at the same time bonded to the activated carbon layer.

According to an advantageous embodiment, the adsorption filter section can comprise a stack of activated carbon layers with an axial stacking direction and the stack can be flowed through in the axial stacking direction. Advantageously, this embodiment enables a configuration of open layers of carrier layer / activated carbon layer with immobilized activated carbon layer. Such layers which are referred to as media layers and comprise a carrier layer as well as an activated carbon layer can be stacked on each other wherein the flow-through direction is in the stacking direction, i.e., orthogonal to the plane of the layers. In a preferred embodiment, two media layers, which are each comprised of a carrier layer and an activated carbon layer, are stacked on each other in such a way that the activated carbon layers of the two media layers adjoin each other immediately. These two media layers form together a stack unit. In the stacked state, within an upper and a lower carrier layer two different activated carbon layers are immediately adjoining each other. Such stack units can be further stacked on each other in order to reach a desired total thickness of the filter device with a corresponding filtration performance. Alternatively, the activated carbon layers and carrier layers can also be arranged alternatingly one behind the other in a media layer or stack unit.

Moreover, it is possible to combine in a simple way different activated carbon types per layer, for example, different raw materials such as coconut, mineral coal, charcoal, or synthetic materials, different degrees of activation, different catalytic properties, and different impregnations. Furthermore, the activated carbon types can comprise acidic-impregnated or alkaline-impregnated activated carbon types, in particular with different degree of activation and with addition of different commonly employed auxiliary agents such as adsorbent materials and absorbent materials which preferably can be present as a grainy loose filling. In this way, an adaptation to the target gas spectrum is possible. In a preferred embodiment, as a basic material for the activated carbon, ion exchanger spheres are used which are produced on the basis of polymer, for example, synthetic resins, in particular of polystyrene cross-linked with divinylbenzene. In particular, it is also possible to combine various layers with a specified activated carbon type, wherein the activated carbon type is however different in each layer.

In an advantageous embodiment, the activated carbon layer at its two faces can be delimited by a carrier layer, respectively. An intermediately positioned activated carbon layer and two carrier layers form a media layer. Expediently, the activated carbon layer can also be adhesively connected with both carrier layers. A media layer or stack unit is comprised thus of two carrier layers and an intermediately positioned activated carbon layer, wherein a plurality of stack units can be stacked on each other.

By a different number of layers or stack units, also great heights with relatively minimal lengths and widths of the adsorption filter section can be realized. The greater height entails longer residence times and an improved effective adsorption and leads to longer service lives of the activated carbon filter.

Expediently, the activated carbon layer can be sealed at its longitudinal side and/or wide side so that together with the carrier layers contacting the faces, a boundary on all sides of the activated carbon layer can be realized. The sealing action at the longitudinal and/or wide sides increases the stability and improves the safety against delamination and displacements in the activated carbon layer. The sealing action of the activated carbon layer can be realized by sealing, for example, with a lateral band, such as a nonwoven, or by an adhesive layer.

Moreover, the carrier medium can be embodied as an open-cell foam, for example, as a polyurethane foam, in which the activated carbon as well as the adhesive are received. Configurations are conceivable in which, for producing the adsorption filter section, first the adhesive is introduced into the open-cell foam of the carrier medium and subsequently the activated carbon is introduced. Possible is also an embodiment where first the adhesive is applied to the activated carbon and the activated carbon / adhesive mixture is then introduced into the open-cell foam of the carrier medium.

According to an advantageous embodiment, the adsorption filter section may comprise a wound body of activated carbon layers that can be flowed through in radial direction relative to a longitudinal axis of the wound body. Aside from the disclosed stacked form of activated carbon layers, the adsorption filter section can be embodied as a wound filter in that the activated carbon layers, for example, are wound onto a core. In this context, the cross section of the core can be round, oval or can be shaped in a different way so that the resulting wound body of activated carbon layers can be embodied correspondingly in a cylinder shape, with oval cross section, as a truncated cone, pyramid or in another shape. Possible is also to position the activated carbon layers in the form of individual closed hollow cylinders with different diameter in a nested arrangement in order to obtain in this way a cylinder-shaped or hollow cylinder-shaped configuration of the adsorption filter section.

According to an advantageous embodiment, the fine filter section may comprise a filter stack which can be flowed through in filter stacking direction and is arranged at one side in front of the adsorption filter section. The fine filter section which can be embodied as a particle filter can be of a multi-stage design. In particular, in this context several layers with different porosity can be arranged as a gradient filter. In principle, it is however also conceivable that the fine filter section can be arranged behind, i.e., downstream of, the adsorption filter section but also in front of, i.e., upstream of, as well as downstream of the adsorption filter section.

In an embodiment, a non-folded filter medium, in particular a single-layer, annularly embodied or stacked filter medium, can be employed as fine filter section. In another embodiment, a zigzag-shape folded filter medium, in particular a star-shape folded round filter medium, can be employed. Beneficial is a filter medium, for example, of cellulose, synthetic foam or nonwoven. Advantageously, the fine filter section can be a single-layer or multi-layer combination of layers of such filter media. As described in connection with the adsorption filter section, the fine filter section in the non-folded form can be configured as a hollow cylinder that can be embodied as a single layer in an annular shape or can be comprised of individual hollow cylinders that are arranged in a nested arrangement. A multi-layer fine filter section can be embodied in particular as gradient filter with individual layers, for example, of different porosity.

By the use of the fine filter section it can be achieved that the adsorption filter section is protected from too great a dust loading and aerosols. In this way, its function of gas separation is impaired only as minimally as possible even for very dust-laden and/or aerosol-laden intake air.

When the cartridge is to be used in an environment which is very strongly loaded with dust, it is conceivable to arrange fluidically upstream of the fine filter section additionally a coarse dust separator so that the fine filter section will not clog so quickly with separated dust and the service life of the cartridge is extended in this way.

Two media layers can be stacked on each other in such a way, respectively, that the activated carbon layers are facing each other. In this way, a stack unit of two media layers results that is delimited by a carrier layer and a fine filter section between which two immediately adjoining activated carbon layers are arranged.

According to an advantageous embodiment, the fine filter section may comprise a round filter which can be flowed through radially relative to a longitudinal axis of the round filter. Such a round filter has the advantage that the inflow of the round filter can be realized radially and in this way the inflow of the intake air of the cartridge can be realized from the radial exterior side and not from the axial bottom side of the cartridge. In this way, such a cartridge can be designed to have a compact construction.

According to an advantageous embodiment, the fine filter section can comprise a round filter that surrounds the adsorption filter section. Expediently, the fine filter section as a round filter can be arranged also radially outside of the adsorption filter section so that an even more compact construction of the cartridge is enabled. Such an arrangement is conceivable for a stacked arrangement of activated carbon layers that can be axially flowed through as well as for wound bodies of activated carbon layers that can be radially flowed through. In case of the stacked arrangement to be axially flowed through, the air stream that has passed radially through the fine filter section can be deflected so that the air stream subsequently flows through the adsorption filter section in axial direction. This arrangement has the advantage of a comparatively large inflow and filter media surface area of the fine filter section that can therefore be designed to have a comparatively minimal pressure loss and a high dust capacity. In particular the design in regard to a minimal pressure loss is advantageous for breathing filters for the person protected by the filter because breathing is made easier in this way.

According to an advantageous embodiment, the round filter and/or the adsorption filter section can be embodied of a multi-layer configuration. A multi-layer construction of the fine filter section as a round filter is in particular advantageous for a flat filter layer such as a nonwoven, in particular when different nonwoven layers are used as a multi-stage fine filter section with different porosity.

According to an advantageous embodiment, the round filter can be designed to be folded. As an alternative embodiment of a fine filter section, a round filter that is folded, for example, in a zigzag shape is advantageous because the folded round filter has a greater filter surface area while having a beneficial size requirement. Also, in air filter technology, folded filter media are very common and therefore can be produced inexpensively and acquired inexpensively.

In an embodiment, for example, a non-folded filter medium, in particular a single-layer annular or a stacked filter medium, can be employed as a fine filter section. In a further embodiment, a zigzag-shape folded filter medium, in particular a star-shape folded round filter medium, can be employed. Beneficial is a filter medium with glass fibers in a glass fiber layer. In this context, for example, a glass fiber nonwoven or glass fiber paper can be employed comprising preferably a cover layer of a spunbonded nonwoven applied on one face or both faces. In this way, in particular a mechanical protection of the usually very sensitive glass fiber medium is achieved, which is in particular advantageous when the glass fiber layer is folded because then the medium in particular can be protected during folding from damage which could cause local leaks or tears. Moreover, such cover layers can serve for improving the mechanical strength of the fine filter section.

According to an advantageous embodiment, the housing can have a radial air inlet relative to a longitudinal housing axis. A radial air inlet is in particular advantageous when using a fine filter section with radial flow direction which can be arranged in combination with an adsorption filter section with axial or radial flow direction. In case of an adsorption filter section with radial flow direction in which the fine filter section also surrounds radially the adsorption filter section, flow paths as short as possible for the air to be filtered result in this way and thus also a flow resistance as minimal as possible, caused by the flow configuration in the cartridge.

According to an advantageous embodiment, the housing can have an axial air inlet relative to a longitudinal housing axis. As an alternative to a radial air inlet, an axial air inlet is particularly beneficial also for a fine filter section with radial flow direction because the housing can be designed simply as a bell without housing bottom, in which the adsorption filter section with integrated or separately arranged fine filter section can be mounted beneficially, and, in this way, the two filter sections can also be easily exchanged, as needed. The housing itself can be manufactured inexpensively because no additional inlet openings must be provided.

According to an advantageous embodiment, a flow-through connecting element can be provided for attachment of the housing to the breathing mask, wherein the connecting element is arranged with its flow channel at a clean air side of the adsorption filter section. The connecting element serves to connect the cartridge detachably but fluid-tightly to the breathing mask. For this purpose, the connecting element has a flow channel that conducts the filtered air from the clean air side of the adsorption filter section into the breathing mask. In case of breathing masks, the cartridge is usually provided with a socket with an external thread as a connecting element which is inserted into a counter element at the breathing mask provided with an inner thread and, in this way, a fluid-tight connection between clean air side of the cartridge and the interior space of the breathing mask is produced. As an alternative to the thread, a bayonet connection is also conceivable however.

According to an advantageous embodiment, the adsorption filter section can comprise a wound body of activated carbon layers that can be flowed through radially relative to a longitudinal axis of the wound body, comprising a closed end plate and an open end plate, wherein the connecting element comprises a socket which is connected to the open end plate. The end plates can be, for example, embodied as sealing adhesive layers. The socket can have an end face which is facing away from the cartridge in axial direction and serves as a sealing surface for sealing when connected with the counter element of the breathing mask.

The connecting element in this context can expediently be connected directly with the adsorption filter section so that the clean air side of the adsorption filter section is connected directly with the flow channel of the socket. For this purpose, the socket is preferably fluid-tightly mounted in the open end plate of the wound body while the oppositely positioned side of the wound body comprises a closed end plate. The socket can be connected in particular by a snap-on connection with the open end plate. In this way, the flow path of the air to be filtered extends from a radial exterior side of the body in radial direction inwardly and can be guided, for example, through the hollow core of the body directly into the flow channel of the socket. In this way, an adsorption filter section with a fixedly mounted socket results which is connectable directly with a counter element of a breathing mask.

According to an advantageous embodiment, the adsorption filter section may comprise a stack of activated carbon layers with an axial stacking direction which can be flowed through in axial stacking direction wherein the connecting element is arranged at a cover of the stack at the clean air side. A socket as a connecting element can be expediently arranged also at an adsorption filter section of a stack of activated carbon layers which can be flowed through axially, when above the stack of activated carbon layers a cover is attached at the clean air side that closes off the stack fluid-tightly so that the filtered air is collected at the clean air side and can flow out only through the socket.

According to an advantageous embodiment, the housing can comprise a housing jacket which is detachably connectable to the connecting element. As a connecting means between housing jacket and connecting element, for example, a snap-on or latching arrangement but also a thread can be provided. When the connecting element, for example, in the form of a socket, is fluid-tightly connected directly with the adsorption filter section, the housing jacket of the housing of the cartridge can be expediently connected detachably with the connecting element. In this way, it is possible to remove the adsorption filter section with the fine filter section arranged thereat from the housing and to exchange it, for example, after loading with dust and/or exhaustion of the adsorption capacity of the adsorption filter section. The housing jacket that is configured in particular to be removable without requiring a tool can be reused in this way so that a cartridge can be realized particularly inexpensively.

According to an advantageous embodiment, means can be provided that prevent the reuse of a used cartridge. When it is to be prevented that an already used cartridge is reused and thereby possibly the permissible service life of the cartridge is surpassed, means can be provided on the connecting element which prevent that an already used cartridge can be screw-connected again to a breathing mask. This can be, for example, in the form of a tab that is arranged on the thread of the socket of the connecting element such that, when removing the cartridge from the breathing mask, the tab is torn off and/or deformed so that it constitutes a mechanical obstacle preventing the cartridge from being screw-connected again to a breathing mask in that it blocks, for example, the thread connection between cartridge and counter element of the breathing mask. Alternatively, it is also conceivable to provide at the connection between housing jacket and connecting element of the cartridge a connecting means such as a tab or a snap-on element that has a rated breakage point and, upon removal of the housing jacket, is destroyed and thus prevents reuse of the used cartridge.

According to a further aspect, the invention concerns a breathing mask with a cartridge wherein the breathing mask comprises a flow-through counter element for a flow-through connecting element of the cartridge. Such a breathing mask can advantageously be used with the cartridge according to the invention because the cartridge provides an adsorption filter section arranged in a housing and at least one fine filter section that is fluidically upstream of the adsorption filter section for separating contaminants from the breathing air, in particular for separation of aerosols. In this context, the adsorption filter section of the cartridge comprises a carrier medium and an activated carbon layer in which the activated carbon particles are immobilized by addition of a fixation agent. In the embodiment according to the invention, the air permeability due to the immobilization of the activated carbon particles is higher than in case of loose fillings with activated carbon particles of comparable particle diameter. The immobilization of the activated carbon particles has moreover the advantage that different geometries of the filter device or of the layers of the carrier medium and of the activated carbon can be produced. Conceivable are round, oval, rectangular shapes as well as any other shapes. Connecting element and counter element can be provided, for example, with thread and counter thread or with a bayonet connection in order to be able to produce a simple and quick connection between cartridge and breathing mask.

According to an advantageous embodiment, a shut-off element can be provided which, when the cartridge is removed, fluid-tightly closes off the counter element. By means of the shut-off element that, for example, can be embodied in the form of a valve membrane, for example, an elastomer, it can be prevented that when exchanging the cartridge while the breathing mask is in use, for example, because the service life of the cartridge has been surpassed or because, due to high loading with dust particles, the flow resistance of the sucked-in air is too great, air with possibly hazardous materials can reach the breathing mask and can be breathed in when the cartridge is removed. Such a shut-off element can be arranged expediently directly fluidically downstream of the thread/bayonet of the counter element.

### BRIEF DESCRIPTION OF THE DRAWINGS

Further advantages result from the following drawing description. In the drawings, embodiments of the invention are illustrated. The drawings, the description, and the claims contain numerous features in combination. A person of skill in the art will also consider the features expediently individually and combine them to meaningful further combinations.

FIG. 1 shows in longitudinal section a cartridge according to a first embodiment of the invention with a stack of activated carbon layers as adsorption filter section and a star-shape folded round filter as a fine filter section and with radial air inlet.

FIG. 2 shows in longitudinal section a cartridge according to a further embodiment of the invention with a stack of activated carbon layers as adsorption filter section and a non-folded fine filter section configured as a filter stack and with axial air inlet.

FIG. 3 shows in a sectioned isometric illustration a cartridge according to a further embodiment of the invention with a wound body of activated carbon layers as adsorption filter section and a star-shape folded round filter as a fine filter section surrounding the adsorption filter section and with radial air inlet.

FIG. 4 shows in a sectioned isometric illustration an adsorption filter section as a wound body and a star-shape folded round filter as a fine filter section surrounding the adsorption filter section.

FIG. 5 shows in a sectioned isometric illustration an adsorption filter section as a wound body and a multi-layer layered round filter as a fine filter section surrounding the adsorption filter section.

FIG. 6 shows in isometric illustration a cartridge with an adsorption filter section as a wound body and a star-shape folded round filter as a fine filter section surrounding the adsorption filter section.

FIG. 7 shows a cartridge in a partially sectioned side view with an adsorption filter section as a wound body and a star-shape folded round filter as a fine filter section surrounding the adsorption filter section.

FIG. 8 shows in isometric illustration a cartridge according to an embodiment of the invention with axial air inlet.

FIG. 9 shows in a sectioned isometric illustration a cartridge according to a further embodiment of the invention with a wound body of activated carbon layers as adsorption filter section and a folded round filter as a fine filter section surrounding the adsorption filter section and with axial air inlet.

FIG. 10 shows in a sectioned isometric illustration a cartridge according to a further embodiment of the invention with a wound body of activated carbon layers as adsorption filter section and a multi-layer layered round filter as a fine filter section surrounding the adsorption filter section and with axial air inlet.

FIG. 11 shows in a sectioned isometric illustration a cartridge according to a further embodiment of the invention with a wound body of activated carbon layers as adsorption filter section and a star-shape folded round filter as a fine filter section surrounding the adsorption filter section, with the housing jacket lifted off.

FIG. 12 shows in a sectioned isometric illustration a similar cartridge with multi-layer round filter as fine filter section, with the housing jacket attached.

FIG. 13 shows in a partially sectioned side view an adsorption filter section of a stack of activated carbon layers with a connecting element that is arranged at a cover at the clean air side.

FIG. 14 shows in schematic illustration a breathing mask according to an embodiment of the invention with a mounted cartridge.

### DETAILED DESCRIPTION

In the Figures same or same type components are identified with same reference characters. The Figures show only examples and are not to be understood as limiting.

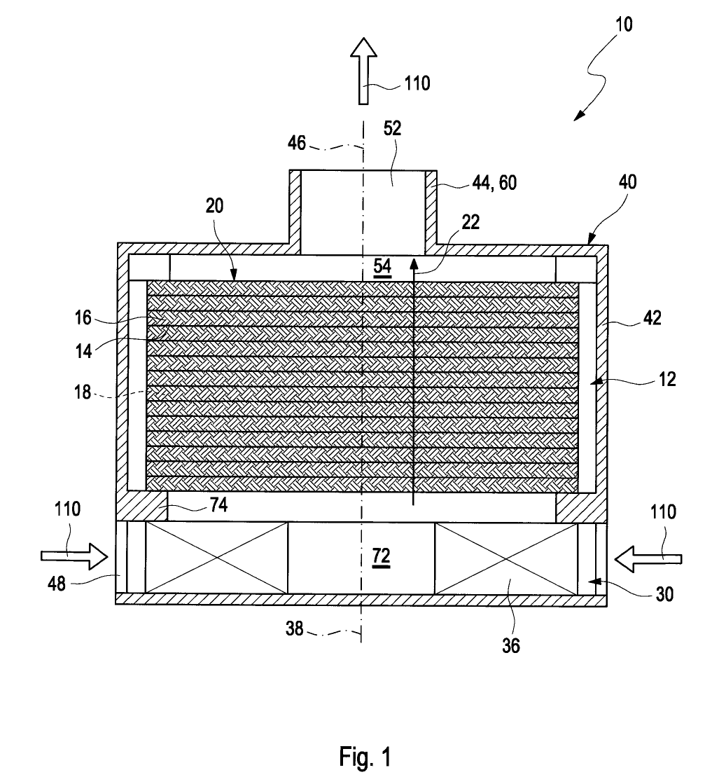

FIG. 1 shows a cartridge 10 in a longitudinal section view according to a first embodiment of the invention with a stack 20 of activated carbon layers 16 as adsorption filter section 12 and a star-shape folded round filter 36 as fine filter section 30 and with radial air inlet 48. The cartridge 10 for a breathing mask 100 comprises the adsorption filter section 12 arranged in a housing 40 and the fine filter section 30 that is fluidically arranged upstream of the adsorption filter section 12 for separating contaminants from the breathing air, in particular for separating aerosols. The adsorption filter section 12 comprises the stack 20 of carrier media 14 and activated carbon layers 16 that are alternatingly following each other, respectively, wherein the activated carbon particles by addition of the fixation agent 18 are immobilized in the activated carbon layers 16. The fixation agent 18 in the activated carbon layer 16 can be a reactive adhesive, for example, on the basis of polyurethane or silane, or a thermoplastic adhesive, for example, on the basis of polyolefins. The carrier medium 14 can be, for example, embodied as a filter nonwoven for particle separation.

The adsorption filter section 12 comprises the stack 20 of activated carbon layers 16 with an axial stacking direction 22; the stack 20 can be flowed through in axial stacking direction 22. The fine filter section 30 comprises the round filter 36 which can be flowed through radially relative to the longitudinal axis 38 of the round filter 36.

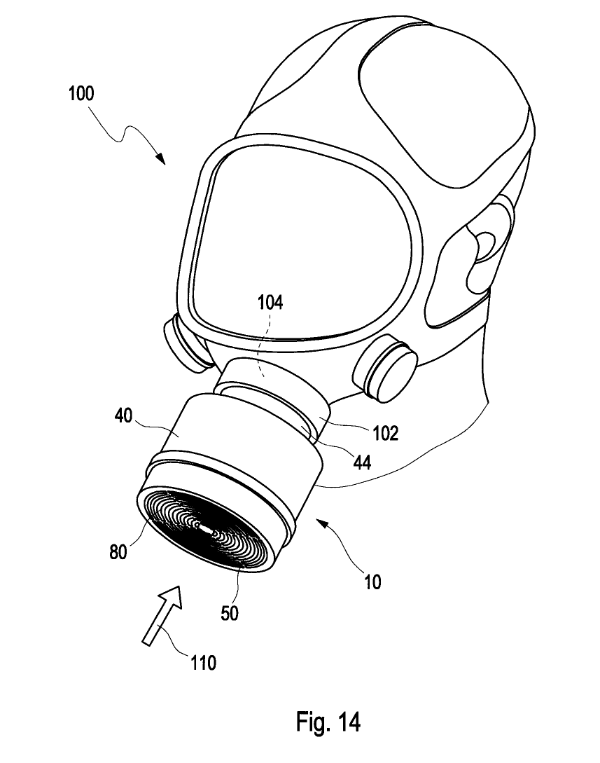

A connecting element 44 in the form of a flow-through socket 60 is provided for fastening the housing 40 of the cartridge 10 to a breathing mask 100 (illustrated in FIG. 14). The connecting element 44 is arranged with its flow channel 52 at the clean air side 54 of the adsorption filter section 12.

The housing 40 comprises, relative to the longitudinal housing axis 46, a radial air inlet 48. The air to be filtered flows in flow direction 110 through the radial air inlet 48, for example, embodied as a perforated screen in the housing jacket 42, into the housing 40 and radially through the fine filter section 30 into the interior 72 of the housing 40. Thereafter, the pre-filtered air flows axially in stacking direction 22 of the adsorption filter section 12 into the clean air region 54 of the housing 40. From here, the filtered clean air flows through the flow channel 52 of the socket 60 in flow direction 110 along the longitudinal housing axis 46 out of the cartridge 10 into the breathing mask 100, not illustrated. The adsorption filter section 12 is secured in the housing jacket 42 by means of a suitable circumferentially extending support 74 and sealed in such a way that the air to be filtered passes through the stack 20 of activated carbon layers 16 and cannot pass along the exterior side of the adsorption filter section 12 into the clean air region 54.

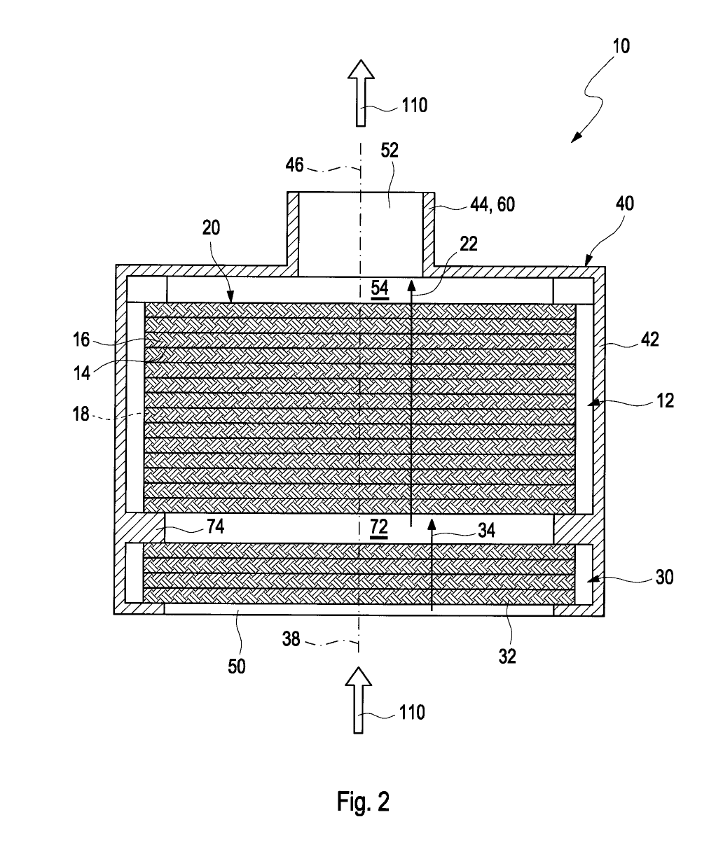

In FIG. 2, a cartridge 10 according to a further embodiment of the invention is illustrated in longitudinal section with a stack 20 of activated carbon layers 16 as adsorption filter section 12 and a filter stack 32 as fine filter section 30 and with axial air inlet 50. The filter stack 32 represents a multi-layer construction of the fine filter section 30, for example, in the form of a multi-stage gradient filter, wherein the individual layers comprise fine filter media with different porosity. The filter stack 32 can be flowed through in the filter stacking direction 34 and arranged at one side upstream of the adsorption filter section 12. The housing 40 comprises relative to the longitudinal housing axis 46 an axial air inlet 50. The air to be filtered passes through the downwardly open air inlet 50 of the housing jacket 42 in axial filter stacking direction 34 into the housing 40 and flows in axial direction through the filter stack 32 provided as a fine filter section 30. Subsequently, the pre-filtered air enters the interior 72 of the housing 40 in order to flow from there in stacking direction 22 through the adsorption filter section 12, as in the embodiment of FIG. 1, in the direction of the clean air region 54 and thus to the flow channel 54 of the connecting element 44. From here, the filtered clean air flows through the flow channel 52 of the socket 60 in flow direction 110 along the longitudinal housing axis 46 out of the cartridge into the breathing mask 100 (not illustrated).

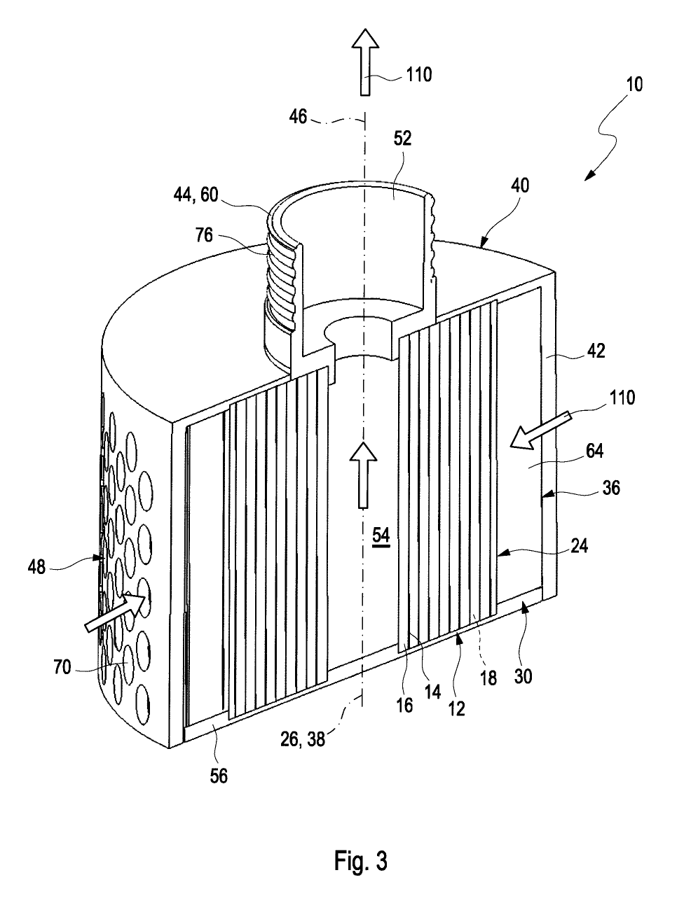

FIG. 3 shows in a sectioned isometric illustration a cartridge 10 according to a further embodiment of the invention with a wound body 24 of activated carbon layers 16 as adsorption filter section 12 and a star-shape folded round filter 36 as a fine filter section 30 surrounding the adsorption filter section 12 with radial air inlet 48. The adsorption filter section 12 comprises in this context the wound body 24 of activated carbon layers 16 that can be flowed through radially relative to the longitudinal axis 26 of the body 24. The fine filter section 30 comprises the round filter 36 which surrounds the adsorption filter section 12. The wound body 24 of the adsorption filter section 12 and the round filter 36 of the fine filter section 30 are arranged in this context coaxial to the longitudinal housing axis 46 with their longitudinal axes 26 and 38.

In the embodiment of FIG. 3, the round filter 36 is embodied by folding with zigzag folds. In the section view, one fold 64 is shown in cutaway view on both sides. Adsorption filter section 12 and round filter 36 comprise a common closed end plate 56 with which the housing 40 is sealed at the bottom relative to the environment.

In FIG. 3, the air to be filtered enters the cartridge 10 at a radial air inlet 48 through the radial inlet openings 70 and flows through the fine filter section 30 in flow direction 110 directly farther through the adsorption filter section 12 in radial direction into the free core of the wound body 24 of the adsorption filter section 12 that represents the clean air region 54. From here, the filtered clean air flows along the longitudinal housing axis 46 through the flow channel 52 of the socket 60 of the connecting element 44.

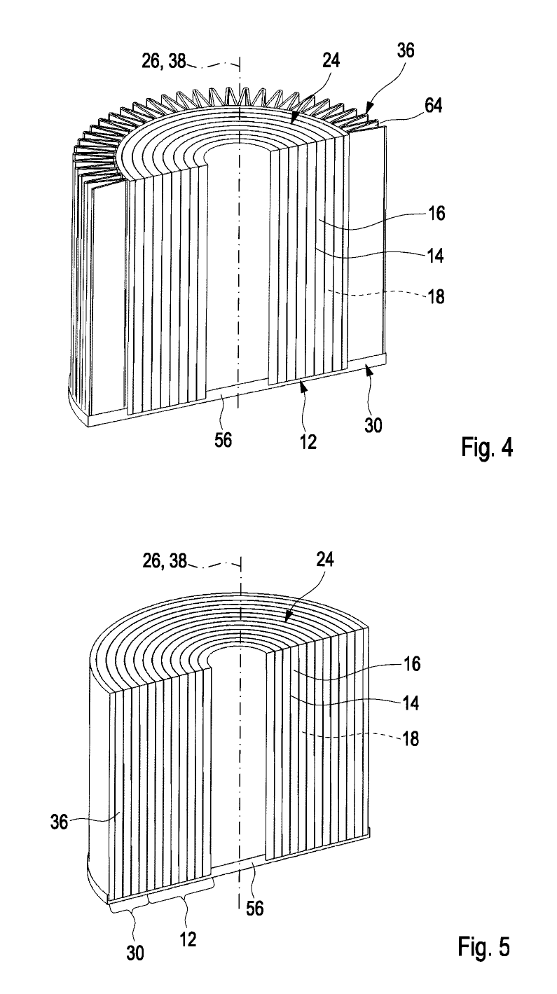

FIG. 4 shows in this context in sectioned isometric illustration an adsorption filter section 12 as a wound body 24 and a round filter 36 that is folded in a star shape and surrounds the adsorption filter section 12 as a fine filter section 30. The activated carbon layers 16 in which activated carbon particles are incorporated immobilized by means of a fixation agent 18, for example, an adhesive, are separated by carrier media 14 and wound onto a core which was removed after the winding process. In this way, the wound body 24 as a whole forms a hollow cylinder. Alternatively, the activated carbon layers 16 each could also be embodied as individual hollow cylinders with different diameters and arranged coaxially inside each other in a nested arrangement on a common longitudinal axis 26. In this way, a radial flow through the adsorption filter section 12 can be realized also. Externally on the wound body 24, the round filter 36 of the fine filter section 30 is applied which is coaxially arranged with its longitudinal axis 38 relative to the longitudinal axis 26 of the adsorption filter section 12. The round body 36 is embodied as a folded filter bellows whose folds 64 project radially in outward direction.

FIG. 5 shows as an alternative to the embodiment illustrated in FIG. 4 an adsorption filter section 12 as a wound body 24 and a round filter 36 as a fine filter section 30 which is of a multi-layer layered arrangement surrounding the adsorption filter section 12. In this embodiment, the fine filter section 30 is also of a layered configuration wherein the different layers, for example, can be embodied in the form of a multi-stage gradient filter with different porosity. In this way, the fine filter section 30 can be embodied as a hollow cylinder with a slightly greater inner diameter than the outer diameter of the adsorption filter section 12 that can then be pushed onto the adsorption filter section 12. The round filter 36 can be embodied, for example, in the form of individual hollow cylinder-shaped sleeves that have different diameters, respectively, so that they can also be pushed onto each other form to a common hollow cylinder in a nested arrangement.

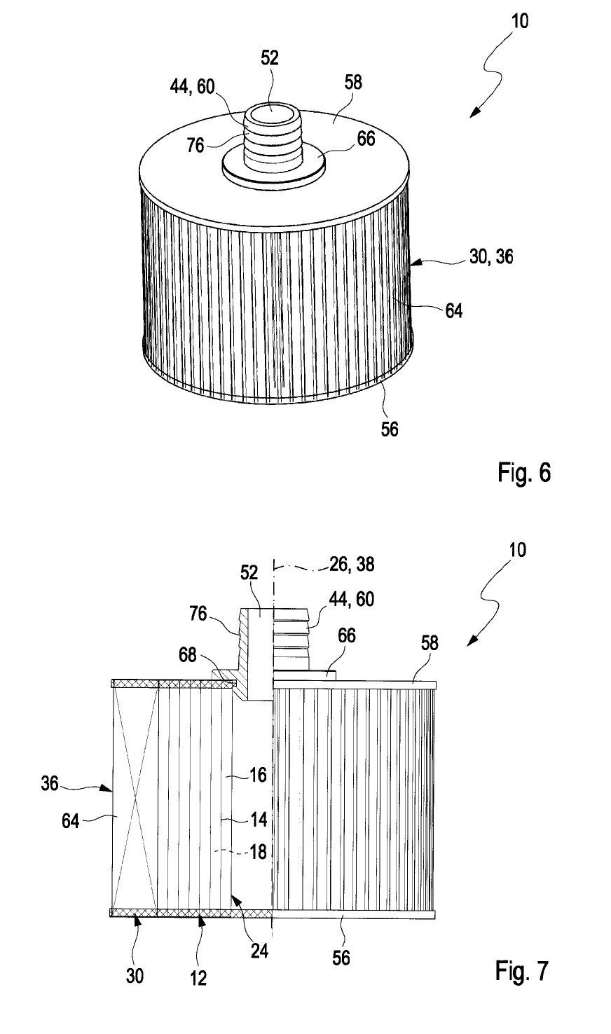

In FIG. 6, a cartridge 10 is illustrated in isometric illustration with an adsorption filter section 12 as a wound body 24 and a star-shape folded round filter 36 as a fine filter section 30 surrounding the adsorption filter section 12. The adsorption filter section 12 with the surrounding round filter 30 is closed off at one side by a closed end plate 56 and at the opposite side by an open end plate 58. In the opening of the open end plate 58 the connecting element 44 with its socket 60 is arranged. The connecting element 44 ends with a collar 66 at the open end plate 58. The cartridge 10 comprises a radial air inlet through the fine filter section 30 with its folds 64. The filtered clean air exits through the flow channel 52 of the socket 60 from the cartridge 10. The socket 60 comprises at its outer circumference an outer thread 76 for connecting with a breathing mask 100, not illustrated.

In this context, FIG. 7 shows in partially sectioned side view the cartridge 10 with the adsorption filter section 12 as a wound body 24 and the star-shape folded round filter 36 as a fine filter section 30 surrounding the adsorption filter section 12. The adsorption filter section 12 comprises the wound body 24 of activated carbon layers 16 that can be flowed through radially relative to the longitudinal axis 26 of the wound body 24. The adsorption filter section 12 with the surrounding round filter 36 as fine filter section 30 is closed off at one side by a closed end plate 56 and at the opposite side by an open end plate 58. The connecting element 44 comprises the socket 60 which is connected to the open end plate 58. The connecting element 44 is arranged with a groove 68 in the opening of the open end plate 58, wherein the opening at the exterior side of the cartridge 10 is fluid-tightly closed off by the collar 66 that is projecting past the connecting element 44. The connecting element 44 can be connected in particular by the groove 68 by a snap-on connection to connect to the open end plate 58.

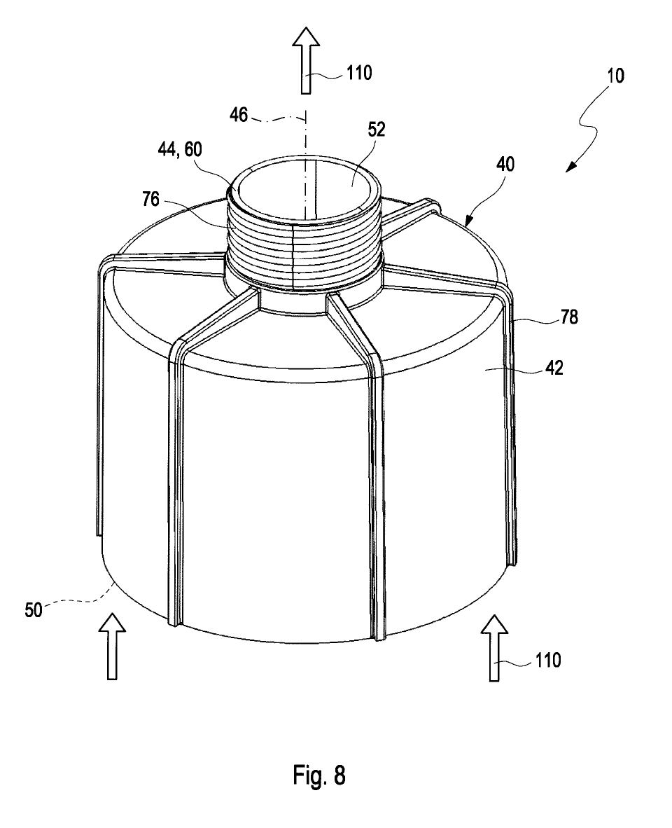

FIG. 8 shows in an isometric illustration a cartridge 10 according to an embodiment of the invention with axial air inlet 50. The cartridge 10 comprises a bell-shaped housing jacket 42 with the axial air inlet 50 arranged at its bottom side. In an embodiment, the housing jacket 42 can be connected with the connecting element 44 in a detachable way, for example, in the form of a snap-on or latching connection, in that it is pushed across the socket 66 of the connecting element 44 and fluid-tightly closes off with the collar 66 of the connecting element 44 that is not visible in FIG. 8. The housing jacket 42 is reinforced by reinforcement ribs 78 so that it can be embodied with a reduced wall thickness in order to advantageously save weight in this way. For protection of the inwardly positioned adsorption filter section 12 and fine filter section 30 against possible damage, the housing jacket 42 can be additionally provided with a protective screen 80 (not visible) arranged in front of the fine filter section 30.

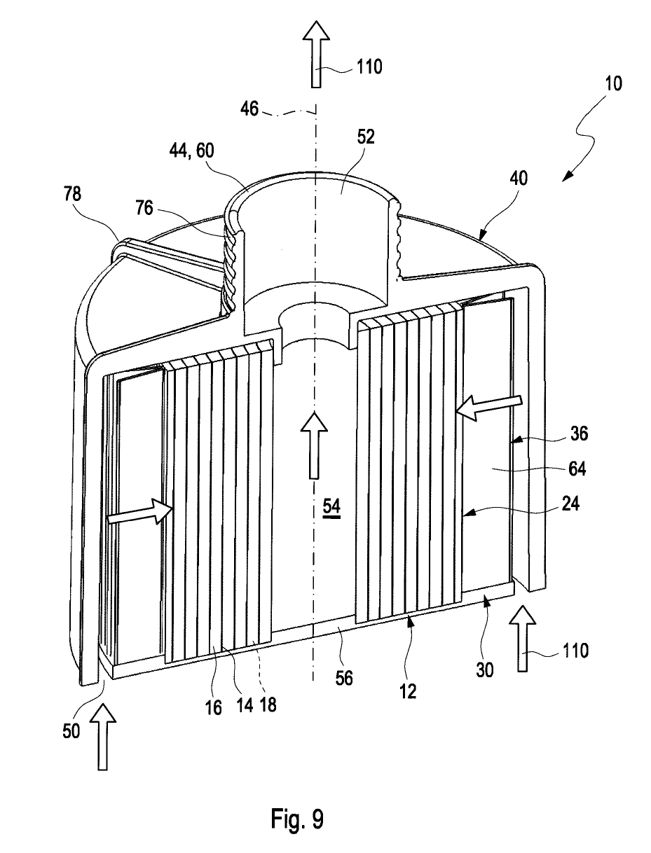

In this context, FIG. 9 shows in sectioned isometric illustration a cartridge 10 according to a further embodiment of the invention with a wound body 24 of activated carbon layers 16 as adsorption filter section 12 and a star-shape folded round filter 36 as a fine filter section 30 surrounding the adsorption filter section 12 and with axial air inlet 50. The cartridge 10 comprises an axial air inlet 50. The air to be filtered flows in flow direction 110 axially along an outer rim of the round filter 36, surrounding as fine filter section 30 the adsorption filter section 12 into the housing jacket 42 because the adsorption filter section 12, and fine filter section 30 at the bottom side are fluid-tightly closed off by a closed end plate 56. The air flows then radially through the fine filter section 30 and the adsorption filter section 12 to the clean air side 54 and exits again axially in the direction of the longitudinal housing axis 46 in flow direction 110 through the flow channel 52 of the socket 60 from the cartridge 10.

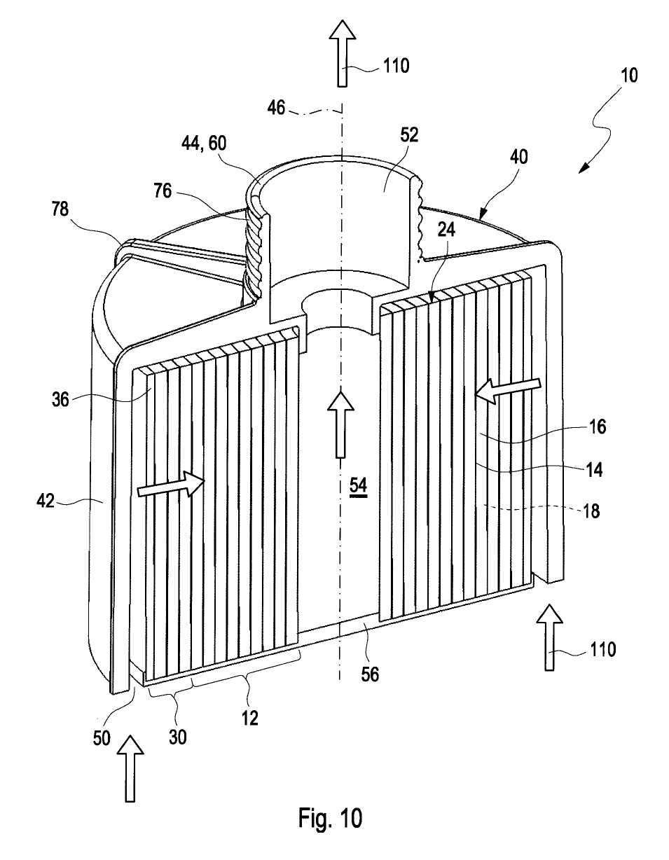

As an alternative to the embodiment illustrated in FIG. 9, FIG. 10 shows in sectioned isometric illustration a cartridge 10 according to a further embodiment of the invention with a wound body 24 of activated carbon layers 16 as adsorption filter section 12 and a multi-layer layered round filter 36 as a fine filter section 30 surrounding the adsorption filter section 12 and with axial air inlet 50. The round filter 36 is embodied in this context with individual layers, for example, as a multi-stage gradient filter. The flow directions 110 in this embodiment are the same as in the embodiment illustrated in FIG. 9. The air passes axially from below into the housing jacket 42, flows radially through the fine filter section 30 and the adsorption filter section 12 to the clean air side 54, and flows then out again axially along the longitudinal housing axis 46 through the flow channel 52 of the socket 60.

In both embodiments illustrated in FIGS. 9 and 10, the housing jacket 42 is connected monolithically with the connecting element 44. Such a workpiece can be inexpensively produced, for example, by an injection molding process. The socket 60 projects with a portion into the clean air side 54 of the adsorption filter section 12 that is formed by the core area of the wound body 24 of the adsorption filter section 12 and is unoccupied after manufacture. In this way, the clean air side 54 is connected fluid-tightly with the flow channel 52 of the socket 60.

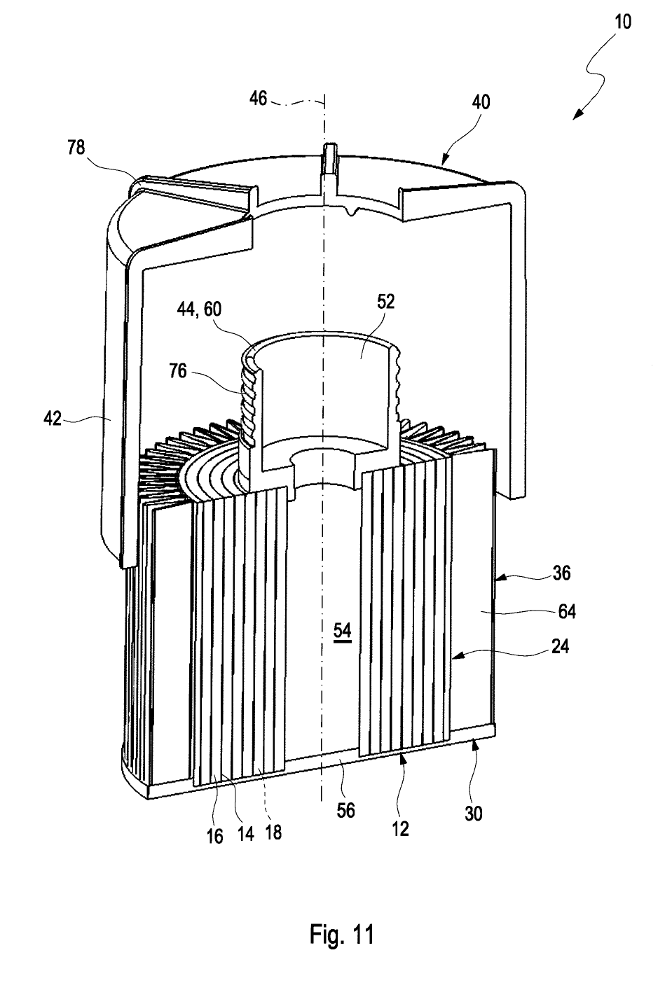

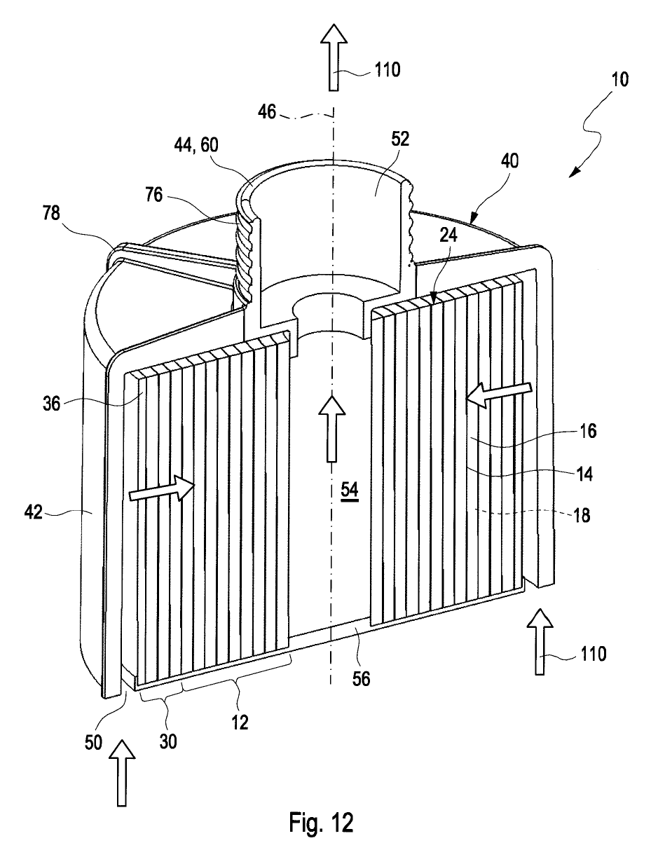

In a sectioned isometric illustration, FIG. 11 illustrates a cartridge 10 according to an embodiment of the invention with a wound body 24 of activated carbon layers 16 as an adsorption filter section 12 and a star-shape folded round filter 36 as a fine filter section 30 surrounding the adsorption filter section 12 and with lifted-off housing jacket 42. The connecting element 44 is arranged at one end of the adsorption filter section 12 such that the flow channel 52 is connected fluid-tightly with the clean air side 54. The detachably embodied housing jacket 42 is illustrated pulled upwardly away from the connecting element 44 while in FIG. 12 the cartridge 10 of FIG. 11 is illustrated with attached housing jacket 42 and annularly embodied multi-layer layered round filter 36 extending about the adsorption filter section 12. The housing jacket 42 is pushed across the socket 60 of the connecting element 44 so that the housing jacket 42 is flush with an inwardly positioned surface of the connecting element 44. The connection of the housing jacket 42 with the connecting element 44 can be embodied, for example, in the form of a snap-on, latching or thread connection which can be arranged on the collar of the connecting element 44 which is flush with the adsorption filter section 12. Alternatively, for the connection between housing jacket 42 and connecting element 44 of the cartridge 10 a connecting means such as a tab or a snap-on element with a rated breakage point can be provided which upon removal of the housing jacket 42 is destroyed and in this way prevents reuse of the used cartridge 10.

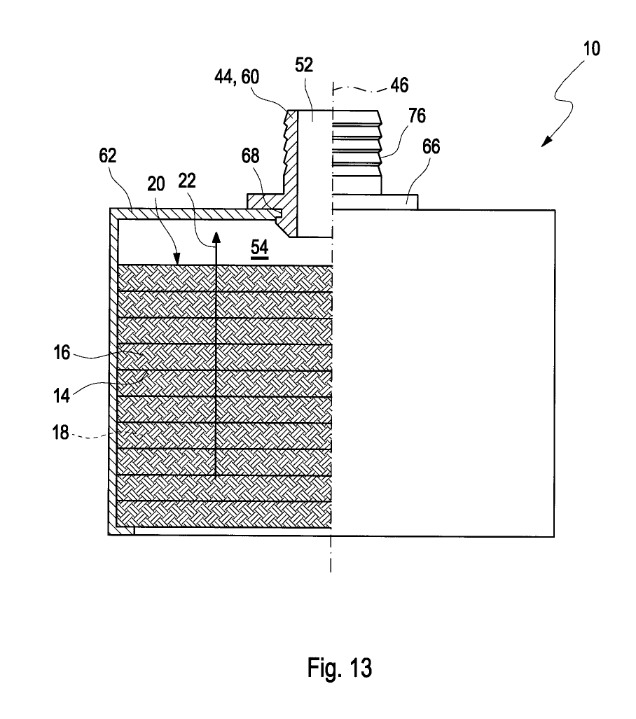

FIG. 13 shows in partially sectioned side view an adsorption filter section 12 of a stack 20 of activated carbon layers 16 with a connecting element 44 arranged on a cover 62 at the clean air side. The adsorption filter section 12 comprises a stack 20 of activated carbon layers 16 with an axial stacking direction 22 which is closed off at the clean air side 54 by a cover 62 wherein the cover 62 expediently covers the radial outer sides of the adsorption filter section 12 in order to seal the radial outer sides as well as provide a stable receptacle for the adsorption filter section 12. Between cover 62 and the top side of the adsorption filter section 12, a free space is formed in this context which serves for collecting the filtered air at the clean air side 54. The connecting element 44 is arranged in an opening of the cover 62 at the clean air side of the stack 20 and engages with a groove 68 the cover 62 so that the connecting element 44 is connected fixedly and fluid-tightly with the cover 62.

FIG. 14 shows in schematic illustration a breathing mask 100 according to an embodiment of the invention with a mounted cartridge 10. The breathing mask 100 comprises a flow-through counter element 102 to which the flow-through connecting element 44 of the cartridge 10 can be coupled. Usually, the connecting element 44 of the cartridge 10 is provided with an exterior thread 76 which engages an inner thread of the counter element 102 and can be screw-connected thereto. Alternatively, it is also conceivable to embody the connection of breathing mask 100 and cartridge 10 by means of a bayonet connection.

The cartridge 10 in the embodiment illustrated in FIG. 14 comprises an axial air inlet 50 through the cartridge bottom side. For protection of the inwardly positioned adsorption filter section 12 and fine filter section 30, the housing jacket 42 is provided with a protective screen 80.

Fluidically inside the counter element 102, a shut-off element 104 can be provided which fluid-tightly closes off the counter element 102 when the cartridge 10 is removed. By means of the shut-off element 104 that, for example, is embodied in the form of a valve membrane, for example, as an elastomer, it can be prevented that air with possibly hazardous materials can reach the breathing mask 100 and can thus be breathed in when changing the cartridge 10.

What is claimed is:

1. A cartridge for a breathing mask, the cartridge comprising a housing and an adsorption filter section arranged in the housing, wherein the adsorption filter section comprises one or more carrier media and one or more activated carbon layers comprising activated carbon particles, wherein the activated carbon particles are immobilized in the one or more activated carbon layers by a fixation agent.

2. The cartridge according to claim 1, wherein the fixation agent is a reactive adhesive or a thermoplastic adhesive.

3. The cartridge according to claim 2, wherein the reactive adhesive is
a polyurethane-based adhesive or a silane-based adhesive and wherein the thermoplastic adhesive comprises a polyolefin.

4. The cartridge according to claim 1, wherein the one or more carrier media are comprised of a nonwoven, respectively.

5. The cartridge according to claim 4, wherein the nonwoven is a filter nonwoven for particle separation.

6. The cartridge according to claim 1, wherein the adsorption filter section comprises a plurality of the activated carbon layers arranged in a stack with an axial stacking direction, wherein the stack is configured to be flowed through in the axial stacking direction.

7. The cartridge according to claim 1, wherein the adsorption filter section comprises a wound body comprising the one or more activated carbon layers and the wound body is configured to be flowed through radially relative to a longitudinal axis of the wound body.

8. The cartridge according to claim 1, further comprising at least one fine filter section configured to separate contaminants from a breathing air, wherein the at least one fine filter section is arranged fluidically upstream of the adsorption filter section.

9. The cartridge according to claim 8, wherein the at least one fine filter section is configured to separate aerosols.

10. The cartridge according to claim 8, wherein the at least one fine filter section comprises a filter stack configured to be flowed through in a filter stacking direction of the filter stack, wherein the filter stack is arranged upstream of the adsorption filter section.

11. The cartridge according to claim 8, wherein the at least one fine filter section comprises a round filter configured to be flowed through radially relative to a longitudinal axis of the round filter.

12. The cartridge according to claim 11, wherein the round filter surrounds the adsorption filter section.

13. The cartridge according to claim 11, wherein the round filter comprises a multi-layered embodiment.

14. The cartridge according to claim 13, wherein the multi-layered embodiment is a multi-stage embodiment.

15. The cartridge according to claim 11, wherein the round filter is a folded filter.

16. The cartridge according to claim 1, wherein the housing comprises a radial air inlet relative to a longitudinal housing axis of the housing.

17. The cartridge according to claim 1, wherein the housing comprises an axial air inlet relative to a longitudinal housing axis of the housing.

18. The cartridge according to claim 1, further comprising a flow-through connecting element configured to connect the housing to a breathing mask, wherein the connecting element comprises a flow channel and is arranged at a clean air side of the adsorption filter section.

19. The cartridge according to claim 18, wherein the adsorption filter section comprises a wound body comprising the one or more activated carbon layers, wherein the wound body is configured to be flowed through radially relative to a longitudinal axis of the wound body, wherein the cartridge further comprises a closed end plate and an open end plate arranged at opposed axial ends of the wound body, wherein the connecting element comprises a socket that is connected to the open end plate.

20. The cartridge according to claim 18, wherein the adsorption filter section comprises a plurality of the activated carbon layers arranged in a stack with an axial stacking direction, wherein the stack is configured to be flowed through in the axial stacking direction, wherein the connecting element is arranged on a cover of the stack arranged at a clean air side of the stack.

21. The cartridge according to claim 18, wherein the housing comprises a housing jacket that is configured to detachably connect to the connecting element.

22. The cartridge according to claim 1, comprising means that prevent reuse of a used cartridge.

23. A breathing mask comprising a cartridge according to claim 1, the cartridge comprising a flow-through connecting element and the breathing mask comprising a flow-through counter element, wherein the connecting element and the counter element is configured to receive the connecting element.

24. The breathing mask according to claim 23, wherein the breathing mask comprises a shut-off element configured to fluid-tightly close off the counter element when the cartridge is removed from the counter element.
